(19) United States
(12) Patent Application Publication
(10) Pub. No.: US 2020/0338654 A1
(43) Pub. Date: Oct. 29, 2020

(54) HIGH THROUGHPUT BANDSAW

(71) Applicant: Kimberly-Clark Worldwide, Inc., Neenah, WI (US)

(72) Inventors: Robert E. Krautkramer, Combined Locks, WI (US); Matthew R. Wilson, Oshkosh, WI (US); Matthew J. Maigatter, Kaukauna, WI (US); John Andrew W. Markel, Appleton, WI (US); James L. Baggot, Neenah, WI (US)

(21) Appl. No.: 16/958,898

(22) PCT Filed: Dec. 26, 2018
(86) PCT No.: PCT/US18/67471

§ 371 Date: Jun. 29, 2020

Related U.S. Application Data
(60) Provisional application No. 62/610,514, filed on Dec. 27, 2017.

(51) Int. Cl. B23D 53/00; B23D 55/04; B23D 55/08; B23D 53/02

(52) U.S. Cl. CPC B23D 53/005; B23D 55/046; B23D 63/08; B23D 53/02; B23D 55/082

(57) ABSTRACT

The present disclosure provides for an apparatus for using continuous, preferably smooth, bandsaw blades to cut a substrate. The current disclosure also discloses using the same for preparing a safe and efficient method for cutting substrates into rolls.

This application claims priority from U.S. provisional Patent Application Ser. No. 62/610,514 filed on Dec. 27, 2017, the entire contents of which are incorporated herein by reference.

### TECHNICAL FIELD

The present disclosure discloses an apparatus for cutting a substrate such as a log into individual portions. The present disclosure, more specifically, relates to a more universal and cost-savings way of cutting a substrate using continuous, thin and smooth bandsaw blades. The current disclosure also discloses a method for cutting the substrate using continuous, thin and smooth bandsaw blades.

### BACKGROUND OF THE DISCLOSURE

Manual and automated circular logsaws and bandsaws for cutting logs are widely known in the art. These types of saws are currently used commercially to cut logs into individual rolls that may be ultimately placed in a dispenser for commercial use. Automated log cutting saws provide for cutting both dry and moistened logs into rolls which minimizes distortion of the final product, especially in terms of shape and cut squareness.

The use of current circular logsaws have limited throughput based on limitations of the number of blades, log feed through lanes and lack of cut quality as well as manufacturing downtime. Current circular logsaws also lack an ability to cut a log multiple times in one continuous motion.

Various attempts have been made to enhance cutting rate of a bandsaw when cutting metallic materials for example. One approach is to form the bandsaw blade in a configuration which will induce pressure variations between the cutting edge of the blade and the substrate being cut. Typical of such efforts is the apparatus set forth in U.S. Pat. Nos. 4,205,571, 4,195,543, 4,160,397 and 4,023,448. In these patents an endless bandsaw blade is formed with a varying height or side elevated profile so that, as the height variations of the blade pass over guide means, the blade is alternately displaced or urged toward and then permitted to move away from the substrate. This alternate slight increase and decrease of the localized pressure of the cutting edge of the blade against the substrate has been found to increase the efficiency of cutting and accordingly reduce the cutting time. While enhanced cutting efficiency is highly desirable as shown in the patents disclosed above, it would be even more advantageous if it could be achieved without the necessity of having such a specially formed bandsaw blade or without removing material during the cutting process.

Therefore a need exists to provide a more universal bandsaw blade that is efficient, versatile and easy to use for cutting any type of substrate into individual rolls or sheets.

### SUMMARY OF THE DISCLOSURE

The current disclosure provides for a more efficient, versatile and high throughput continuous or endless bandsaw blade wherein the blade is stationary and moves in a serpentine path. The current disclosure also provides for less potential user interaction with the bandsaw blade, fewer bandsaw blades become worn out over time, there are no limitations based on the diameter of the blade for cutting, and the ability to attach an in-line sharpening tool wherein the tool may be used to continuously or intermittently sharpen the bandsaw blade.

Generally, one embodiment of the disclosure discloses an apparatus which entails an endless smooth edged endless cutting bandsaw blade. The bandsaw blade may be attached to the apparatus by two or more adjustable rollers wherein the rollers aid in moving the bandsaw blade.

Unlike other saws, the use of a continuous bandsaw blade provides higher substrate throughput and offers a continuous cut on the same point of the substrate which enables a quicker cut time as well as a consistent substrate cut. In addition, the current disclosure encompasses thinner band saw blades than circular saw blades than what have been previously used. The current disclosure optionally encompasses a serpentine blade in which the blade is fused together to make a complete 360 degree loop.

Specifically, in another embodiment, the disclosure may include one or more blade sharpening tool hardware's which are mounted to the frame of the apparatus in a position between the roller and the bandsaw. The sharpening tools are most preferably attached to the frame facing the most outward facing roller. Such a blade sharpening tool may sharpen one or more blades continuously or intermittently. A blade sharpening hardware may be enclosed in a box. The sharpening hardware tool box allows for clean cutting with lower fire risk and improves overall safety. Any blade sharpening hardware known in the industry may be used herein. One example of a sharpening tool may be made from an abrasive aluminum. An additional embodiment of the current disclosure is the utilization of a continuously or intermittently blade sharpener while the apparatus is in use. This greatly reduces substrate cutting downtime. As a further benefit of using such a blade sharpening device is the minimal saw dust that is created thus further reducing substrate cutting downtime.

In a further embodiment, thin smooth bandsaw blades are used. Bandsaw blade thickness is preferably about 15 thousandths of an inch to about 30 thousandths of an inch (more preferably about 24 thousandths of an inch thick). The thin smooth bandsaw blades are routed in a manner wherein the substrate may be cut multiple times simultaneously. The number of cutting lanes used in the present disclosure may be from 2 to 40 lanes with or without using a log infeed system. An example of a preferred bandsaw blade disclosed herein is a nickel plated blade made of steel. However, any metal maybe utilized or any unconventional material may be utilized as well. Cutting devices of different sizes and/or configurations may be employed for different substrates. An advantage of using a thinner bandsaw blade is seen lesser drag on the product (advantage) hence allowing the substrate to be cut multiple times at the same location. Another advantage is the minimal collection of saw dust in and around the bandsaw and apparatus.

A blade's (preferably a bandsaw with a serpentine blade) path disclosed herein is fixed. The blade makes multiple passes (of at least two or more) cutting through a substrate in the direction the substrate is traveling.

In one embodiment, the log may be secured in a pocket on the sprocket wheel by a dead plate wherein the log is fully cut into rolls in one continuous motion. After the log is cut the individual rolls are released by the dead plate at the bottom of the sprocket wheel and then dropped into a chute or conveyor that carries the rolls away.

In an alternative embodiment, the log may simply be fed directly into the bandsaw blade horizontally, vertically or at any angle between 0 and 180 degrees.

In a first embodiment, the present disclosure discloses an apparatus for cutting flexible substrates into individual smaller substrate pieces comprising:
a frame having an upper surface lying in a first plane;
one or more pulleys attached to the frame;
a motor for driving one or more pulleys wherein the motor is optionally connected to the frame;
an endless stationary band saw blade mountably engaged with one or more pulleys, the bandsaw blade having an upper and lower edge wherein stationary herein is meant to depict the blade as moving in one continuous direction where the blade is secured as it moves around the apparatus;
a moveable carriage for receiving and advancing the substrate through a cutting lane thereby cutting the substrate along a plane which is orthogonal to the longitudinal axis of the substrate; and optionally
a sharpening tool attached to the frame of the apparatus wherein the sharpening tool is preferably attached to the frame facing the most outside positioned pulley(s) so as to sharpen the bandsaw blade.

The first plane is substantially perpendicular to a cutting plane which is also orthogonal to the longitudinal axis of the substrate.

In a second embodiment, the apparatus according to the preceding embodiment, wherein the substrate is cylindrical rolls, logs, pipe, tube, food product, dry or wet rolls of paper or wet wipes.

In a third embodiment, the apparatus according to the preceding embodiments, wherein the bandsaw blade is smooth.

In a fourth embodiment, the apparatus according to the preceding embodiments, wherein the bandsaw blade is serpentine and forms a loop.

In a fifth embodiment, the apparatus according to the preceding embodiments, wherein the bandsaw blade further comprises a plurality of cutting teeth disposed on at least the upper edge and defining the cutting plane.

In a sixth embodiment, the apparatus according to the preceding embodiments wherein there are from about 2 to about 40 cutting lanes. More preferably there are 2 to about 25 cutting lanes.

In a seventh embodiment, the apparatus according to the preceding embodiments, wherein the moveable carriage is a sprocket wheel, or any other device that may hold the substrate.

In an eighth embodiment, the apparatus according to the preceding embodiments, wherein the motor is a servomotor.

In a ninth embodiment, the apparatus according to the preceding embodiments, wherein the sharpening blade tool sharpens continuously or intermittently.

In a tenth embodiment, the apparatus according to the preceding embodiments, wherein the sharpening blade tool is attached to the frame of the apparatus between the bandsaw blade and the outer most facing pulley(s).

In an eleventh embodiment, the apparatus according to the preceding embodiments, wherein the bandsaw saw blade is from about 15 thousands of an inch to about 30 thousands of an inch thick.

In a twelfth embodiment, the apparatus according to the preceding embodiment, wherein the bandsaw saw blade makes continuous cuts through the substrate at the same point at each pass.

In a thirteenth embodiment, the apparatus according to the preceding embodiments, wherein the sprocket wheel comprises a plurality of evenly spaced apart pockets comprise from about two to about forty pockets and most preferably from two to about 25 pockets.

In a fourteenth embodiment, the apparatus according to the preceding embodiments, wherein the moveable carriage has a holding device to cover the substrate in the pocket.

In a fifteenth embodiment, the apparatus according to the preceding embodiment,
wherein the holding device is a dead plate.

In a sixteenth embodiment, the apparatus according to the preceding embodiments, wherein the pulley(s) are adjustable to the length of the product being cut. More specifically, the guide pulley may be moved to adjust the product length.

In a seventeenth embodiment, the method for cutting flexible substrates having a longitudinal axis, the method comprising:
depositing and holding the substrate into a moveable carriage;
rotating the moveable carriage with a motor;
a motor for driving one or more pulleys through one or more cutting lanes wherein the pulleys move an endless stationary bandsaw blade;
continuously cutting the substrates at the same location during each pass with the bandsaw blade; and optionally
sharpening the bandsaw blade with a sharpening blade tool while cutting the substrates.

In an eighteenth embodiment, the method according to the preceding embodiment, wherein the substrate is cylindrical rolls, logs, pipe, tube, food product, dry or wet roll of paper or wet wipes.

In a nineteenth embodiment, the method according to the preceding embodiments, wherein the blade is serpentine and forms a loop.

In a twentieth embodiment, the method according to the preceding embodiments, wherein the bandsaw blade is smooth.

In a twenty-first embodiment, the method according to the preceding embodiments, wherein the bandsaw blade further comprises a plurality of cutting teeth disposed on at least one edge and defining the cutting plane.

In a twenty-second embodiment, the method according to the preceding embodiments, wherein there are from about 2 to about 40 cutting lanes. Two to about 25 cutting lanes is most preferred.

In a twenty-third embodiment, the method according to the preceding embodiments, wherein the motor is a servomotor.

In a twenty-fourth embodiment, the method according to the preceding embodiments, wherein the sharpening blade tool sharpens continuously or intermittently.

In a twenty-fifth embodiment, the method according to the preceding embodiments, wherein the sharpening blade tool is attached to the frame of the apparatus between the bandsaw blade and the outer most facing pulley(s).

In a twenty-sixth embodiment, the method according to the preceding embodiments, wherein the bandsaw saw blade is from about 5 thousandths of an inch to about 60 thousandths of an inch thick.

In a twenty-seventh embodiment, the method according to the preceding embodiments, wherein the moveable carriage is a sprocket wheel, index conveyor, bomb-bay door or any other similar device that may hold the substrate.

In a twenty-eighth embodiment, the method according to the preceding embodiments, wherein the moveable carriage has a holding device to contain the substrate in the pocket.

In a twenty-ninth embodiment, the method according to the preceding embodiment, wherein the holding device is a dead plate.

The above summary of the present disclosure is not intended to describe each embodiment or every implementation of the present disclosure. Advantages and attainments, together with a more complete understanding of the disclosure, will become apparent and appreciated by referring to the following detailed description and claims taken in conjunction with the accompanying drawings.

### BRIEF DESCRIPTION OF DRAWINGS

The disclosure may be more completely understood in consideration of the following detailed description of various embodiments in connection with the accompanying drawings, in which:

FIG. 1 is a side top view of an apparatus with a chute tray angled down into the sprocket wheel and a chute tray at the bottom of the sprocket wheel;

FIG. 2 is a view of a sprocket wheel with pockets, a dead plate, and a bandsaw blade rotated by six adjustable rollers;

FIG. 3 is a top view of an apparatus that includes a sprocket wheel, a main pulley drive, and adjustable rollers.

FIG. 4 depicts an example of the blade path.

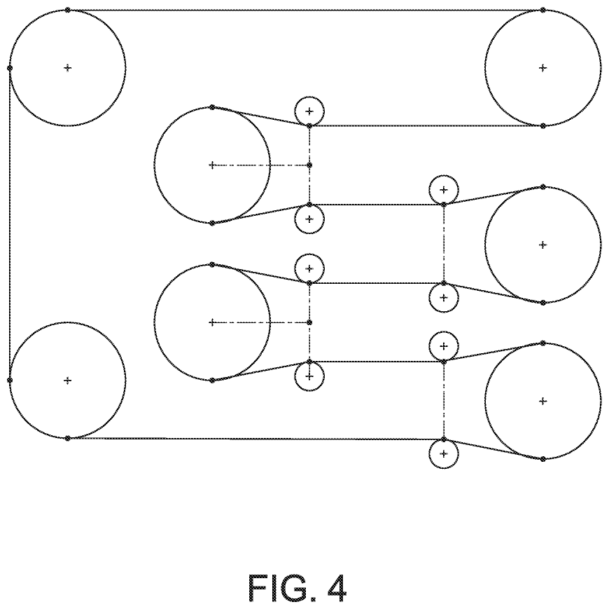

FIG. 5 depicts an example of the blade path.

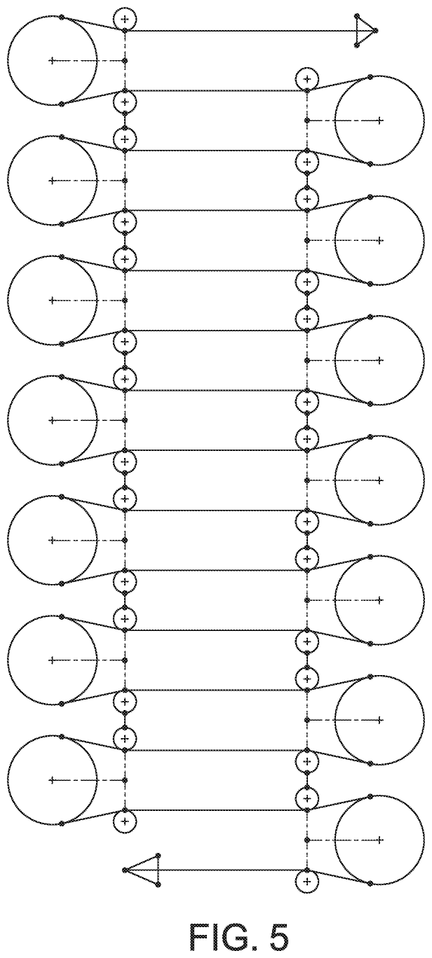

While the disclosure is amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the scope of the disclosure.

### DETAILED DESCRIPTION OF THE DISLOSURE

Each example of this disclosure is provided by way of explanation and is not meant as a limitation. For example, features illustrated or described as part of one embodiment or figure can be used on another embodiment or figure to yield yet another embodiment. It is intended that the present disclosure include such modifications and variations.

Although some suitable dimensions, ranges and/or values pertaining to various components, features and/or specifications are disclosed, one of skill in the art, incited by the present disclosure, would understand desired dimensions, ranges and/or values may deviate from those expressly disclosed.

When introducing elements of the present disclosure or the preferred embodiment(s) thereof, the articles “a”, “an”, and “the” are intended to mean that there are one or more of the elements.

The terms “comprising”, “including” and “having” are intended to be inclusive and mean that there may be additional elements other than the listed elements. Many modifications and variations of the present disclosure can be made without departing from the spirit and scope thereof. Therefore, the exemplary embodiments described above should not be used to limit the scope of the invention.

The term “blade” disclosed herein refers to a cutting device. The blade disclosed herein more specifically refers to a bandsaw. A bandsaw is a saw with a sharp blade consisting of a continuous smooth or toothed band of metal that cuts material, for example, substrates made from food or wood.

The term “substrate(s)” disclosed herein refers to any type of substantial cylindrical rolls or logs. For example, the substrate could be a solid cylinder of material, a hollow cylinder such as a pipe or tube, or a wound roll of a web. The low rigidity substrate may be other soft or flexible logs such as foams, sponge-like materials, food products, etc. For example, the substrate may be a log of a cheese product or meat product. Also, the substrate may be a dry roll of paper, such as tissue paper. Coreless rolls can be cut precisely by the bandsaw disclosed herein.

The substrate is retained by any movable carriage that may be used to hold and/or control the substrate so as to cut the substrate into pieces.

Bandsaw blades are sold commercially in large coils which may be welded together as needed so as to extend the length of the bandsaw blade and/or to connect the bandsaw blade together to make a continuous loop.

In one general embodiment, a substrate may be delivered initially to an infeed conveyor or down a chute that is preferably metal. The delivery may be metered if necessary, such as by a controllably movable gate. The conveyor is mounted on a frame. The conveyor is preferably made of stainless steel but may be made of any metal. The conveyor may be movably mounted such that it can be in a lowered position during use or can be in a raised position for maintenance or cleaning. The conveyor may be mounted to the frame by support arms, which are connected to struts and servo motors. These support arms raise or lower the conveyor in response to a signal from an actuator.

The infeed conveyor is equipped with concave holders which cradle the logs and prevent them from falling off the conveyor. The holders are preferably shaped with planar walls and a curved bottom. This configuration allows the roll to be dropped into the holder in a vertical manner, rather than rolling in at an angle. The optional metering gate may also assist in assuring this vertical delivery. Holders of different dimensions and configurations may be employed for different substrates. For example, the holder may have a curved bottom and a supporting wall. The holder may be a shelf which is substantially perpendicular to the direction of motion of the conveyor. The conveyor may be equipped to support a variety of interchangeable holders.

The substrates may be delivered to the infeed conveyor in a consistent manner, such that the substrates are in alignment with each other. It is preferred that the substrates are also substantially aligned with respect to the bandsaw apparatus. Portions of the bandsaw that extend beyond the outermost saw blades may produce rolls which have dimensions and/or edges that are undesirable. If an end of the log does not extend to the outermost blade, the roll from that end may also have dimensions and/or edges that are undesirable. These rolls with non-optimal or inconsistent dimensions may then be treated as waste or may be recycled or put to other uses. It is preferred that a relatively small portion of the substrate is cut from each end of the substrate by the outermost bandsaw blades such that the inconsistent rolls account for less than 10 percent, preferably less than 5 percent, and preferably between about 1 percent and 3 percent of the total length of the log. Any logs that are out of alignment may be aligned manually as needed, although an automated alignment system may also be employed.

The infeed conveyor delivers the substrate to any device or moveable carriage that may hold, control or convey the substrate. On example, of such a device is a sprocket wheel.

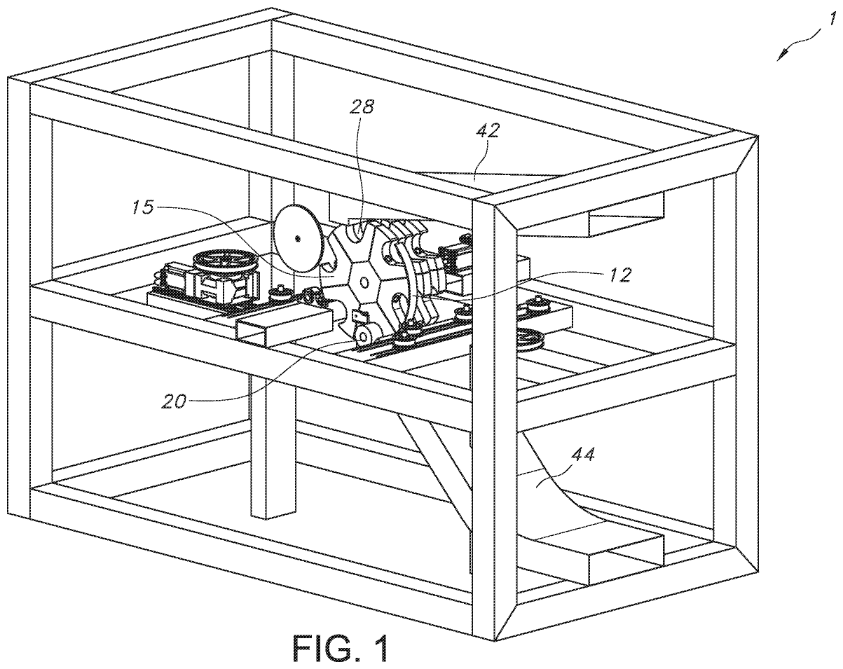

In another embodiment, in order to introduce a substrate into a sprocket wheel of the apparatus the substrate is first placed into a chute preferably a sheet metal with an angled, preferably declined, chute or a conveyor where the log(s) are introduced into a sprocket wheel. The chute may be at any angle from about 20 degrees to about 160 degrees in relation to the sprocket wheel. See FIG. 1. An optional release door, such as any known in the art, may be used at any point in the chute prior to the substrate being placed in the pocket of the sprocket wheel. This release door would serve to equally space the substrates apart as they proceed down the chute and into the pocket of the sprocket wheel.

The sprocket wheel 15 rotates the substrate into the cutting area (toward the bandsaw blade) in a clockwise direction. The rotation of the sprocket is preferably a continuous motion, although intermittent or stepwise movement may be employed. The sprocket rotates the divided substrate away from the cutting area such that the individual substrate pieces (rolls) may be collected. The rolls may be dropped onto a diverter, into a receptacle or bin, or onto a conveyor or into a chute, preferably metal. The rolls may also be ejected from the sprocket wheel. The rolls may then be delivered for subsequent processing and/or packaging or may be tested to monitor product quality. The sprocket wheel is mounted on an apparatus frame 1 and rotates on a rotating shaft attached to a servo motor.

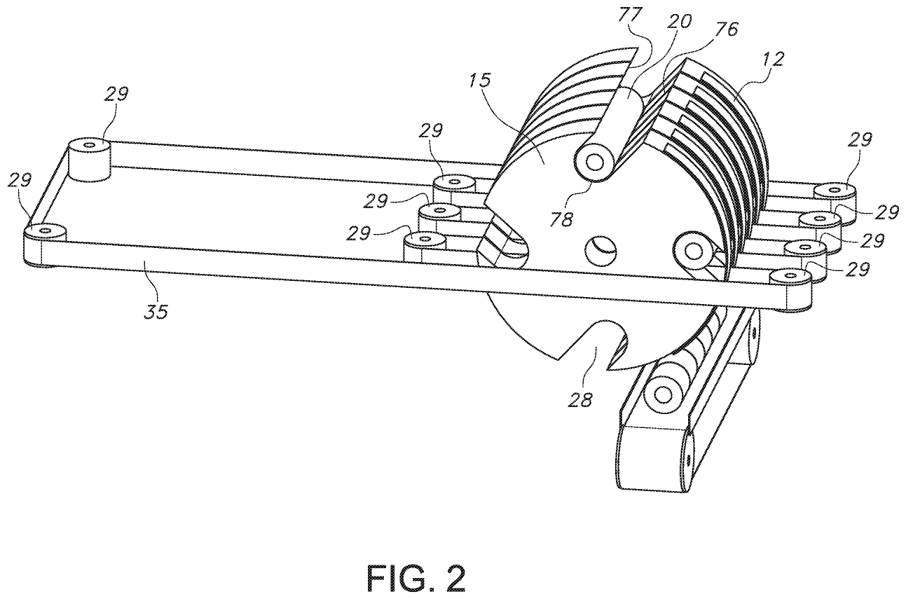

After the substrate is introduced into the sprocket wheel it is deposited into a pocket within the sprocket wheel. The sprocket wheel has pockets for delivering the substrate to the cutting area. In the embodiment shown in FIG. 2, the pocket has a base 78, planar portions 76, and a curved portion 77. The curved portion forms a closed end of the pocket, with an open end formed by the space between the planar portions. The planar walls 76 of the pocket are at an angle of 60-degrees from the horizontal axis, which is defined by the base of the pocket. The configuration in this embodiment provides for ease of delivery of the substrate into the pocket from the infeed conveyor and also provides stability to the substrate during the cutting procedure. The substrate is preferably delivered to the sprocket wheel when the receiving pocket is at an angle of 45-degrees from the horizontal axis. Other angles of delivery may be used, depending on the overall configuration of the apparatus. The log may be delivered when the receiving pocket is between 30-degrees and 80-degrees from the horizontal axis for example.

Pockets of different dimensions and configurations may be employed for different substrates or final products. The sprocket wheel may be equipped to support a variety of interchangeable pockets.

In another embodiment the pocket may have one open end and one closed end on the sprocket wheel. The pocket has a first planar surface, a second planar surface, and a concave surface between the planar surfaces wherein the second planar surface optionally has teeth to hold the logs in place. The concave surface forms the closed end of the sprocket wheel wherein the concave surface holds the rolls in the pocket such that the cutting force is counterbalanced by the pocket. A roll retention device disclosed herein is a dead plate to further secure the substrate in the pocket. The substrates are then divided into a plurality of rolls where the cutting bandsaw, preferably smoothed as opposed to toothed, may cut the substrates through channels (spaces between the sprocket wheels). See FIG. 2. The bandsaw continuously cuts through the substrate at the same location on the substrate. Once the substrates are cut into pieces the dead plate is released as the sprocket rotates to the bottom of its wheel. The cut log pieces are released from the pocket and thereafter the substrate pieces are deposited into a chute or conveyor to be carried away.

As shown in FIG. 1, there is provided, in general, a chute 42, preferably metal, or conveyor that carries a substrate, for example a log 20, into a sprocket wheel 15. Attached to the chute 42 or conveyor is an optional gate or door to help better manage and separate the log 20 prior to dropping into a pocket 28 of the sprocket wheel 15. There may be two or more sprocket wheels 15 per apparatus 1 at which the speed of the apparatus 1 is controlled by an automated or manual sprocket drive system and/or an automated or manual continuous blade drive system. The number of drives are dependent on the number of bandsaw cutting lanes available. Commercially there may be anywhere between 2 to 40 cutting lanes. Accordingly the more cutting lanes used the more likely additional drive (or motor) systems will be required. The speed of both the sprocket drive system and the blade drive system is determined by the thickness, weight and/or length of the substrate.

Any type of bandsaw may be used to cut the substrate and/or roll. For example, a smooth or toothed bandsaw blade may be used wherein a smooth bandsaw blade is preferred. Alternatively, a bandsaw blade may be used together with a water jet cutting apparatus, such as is available from FLOW INTERNATIONAL, Seattle, Wash. Bandsaws of different sizes and/or configurations may be employed for different substrates.

In an embodiment of the invention, the blades, preferably bandsaw blades, may be operated by one common motor or may be connected to separate motors preferably servo motors. Although it is possible that two or more substrates might be in contact with the bandsaw blades at one time, it is preferred that the blade is in contact with only one substrate during a cutting cycle.

The bandsaw blade 35 cuts an entire log 20 into individual rolls. After the log is cut into individual rolls, the individual rolls are dispensed from the sprocket wheel. This dispensing can take the form of allowing the roll to fall from the pocket. The sprocket and/or pocket can be equipped with a movable finger for example to eject the rolls from the pocket, in a substantially horizontal motion. If the rolls are allowed to fall from the pocket, it may be desirable to do so at the bottom of the sprocket-wheel. For example, a belt or series of belts may be used to cover the openings of the pockets until the exit point is reached or a shoe or plate may be used. The dimensions of the belt or shoe necessary to control the dispensing can vary by the type of substrate and the shape of the pockets. The belt or shoe may be connected to the frame by a mounting bracket. In any of these embodiments, an exit dead plate 12 may also be employed to guide the dispensed roll to the desired location.

The motion of the infeed conveyor and the sprocket wheel may be coordinated by methods known to those skilled in the art. For example, a programmable logic control (PLC) system such as manufactured by ALLEN BRADLEY can be used to coordinate any combination of the infeed conveyor, the sprocket wheel, the saw blades, the index conveyors, and the gates that open/close the conveyor. It is desirable that the total speed of the apparatus is sufficiently fast to provide for efficient mass production of the final product. The rate of distribution is preferably at least 300 rolls per minute, more preferably at least 1200 rolls per minute. Higher or lower speeds may be optimal for different substrates.

There may be two or more sprocket wheels 15 per apparatus at which the speed of the apparatus is controlled by both a sprocket drive system and/or a continuous blade drive system. Additionally, the speed of both the sprocket drive system and the blade drive system is determined by the thickness, weight and/or length of the substrate.

A log which is nestled into the pocket 28 of the sprocket wheel 15 is supported along its entire length and rotated into a cutting area (FIG. 2) where it is divided into rolls by a bandsaw 35. The divided log is rotated past the cutting area, and the individual rolls may be secured in the pockets by a roll retention device such as a dead plate 12. The log is secured in the pocket 28 with a dead plate 12 that covers the outside of the sprocket wheel 15. The dead plate 12 prevents the rolls from leaving the pockets until the desired roll exit point is reached. Or alternatively, the pockets 28 may be shaped to hold logs during the cutting operation without the need to use a secondary clamping device such as a dead plate. Unwinding and scuffing of the rolls is also prevented by the retention device. After the log is cut continuously and multiple times into individual rolls, the rolls drop into a conveyor or a chute that carries the rolls away.

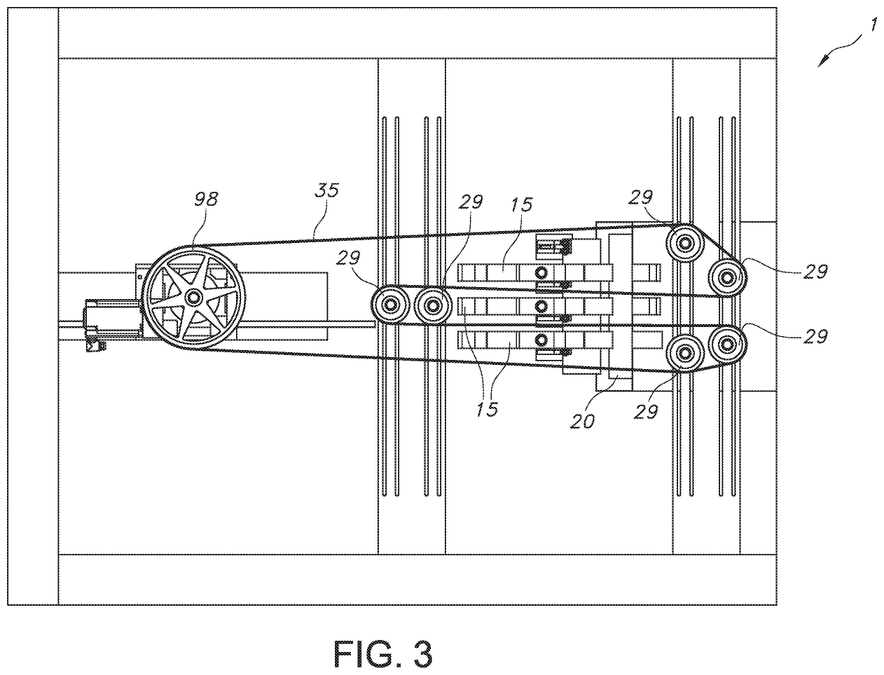

Another aspect of the disclosure is where the sprocket wheel 15 is rotatable which contains two or more evenly spaced apart pockets 28 wherein each pocket has one open end and one closed end. The pockets 28 circularly convey the logs through the cutting process. The bandsaw blade may be serpentine in which a series of blades are fused together to make a complete 360 degree loop. See FIG. 3. The blade may make multiple passes cutting through a log as it is rotationally lowered into the blade's path by for example a sprocket wheel.

A further aspect of the current disclosure pertains to two or more evenly spaced apart rotatable and adjustable rollers 29 wherein the rollers are connected to the bandsaw blade 35. See FIG. 3. FIG. 3 depicts six rollers wherein there are three pairs which demonstrates that each roller in a pair is evenly spaced apart from each other.

There is also a main drive pulley 98 that manually or by automation drives the bandsaw blades 35 with the aid of the rotatable and adjustable rollers 29. The drive pulley 98 serves as a blade drive system which rotates the rollers 29 that moves the blade 35. See FIG. 3.

An additional aspect of the disclosure provides a sharpening of the blades 35 at a single location on the blade 35 wherein the blade may be sharpened continuously or intermittently at time intervals of 2 seconds, 3 seconds, 5 seconds, 10 seconds, 20 seconds, 30 seconds, 1 minute, 2 minutes, 5 minutes or longer. The sharpener is preferably a 2-stone grinder and is preferably located in a box at the back end of a roller to sharpen the bandsaw blade. Any blade sharpener know in the art may be used herein. By using a blade sharpener in a manner in which the bandsaw or apparatus does not need to be turned off not only reduces apparatus downtime but also reduces amount of saw dust build up on the apparatus thus allowing for a cleaner environment, better safety precautions and extends blade life.

Pockets of different dimensions and configurations may be employed for different substrates or final products. The sprocket wheels may be equipped to support a variety of interchangeable pockets depending on the size and weight of the substrate.

The sprocket wheel itself may have grooves to better hold the pocket. The sprocket wheel is preferably made of metal, and the pockets are preferably made of cast nylon. Preferably, the sprocket wheel comprises 2-24 singular pockets, equally spaced 45-degrees from each other.

There may be a multiplicity of channels (the space between the sprocket wheels) (FIG. 2), which are configured so as to allow the blades to pass through them. The spacing of these channels in between the sprocket wheels help define the width of the product that is produced. The spacing between the channels may at least be one nanometer.

The bandsaw 35 comprises preferably a smooth blade and is connected to the apparatus by adjustable rollers (or pulleys), for example, as depicted in FIG. 3. The number of rollers used depends on the thickness of the blade and number of substrates. The rollers may be mounted separately, or can be mounted in pairs. The rollers may be adjustable independent of each other, or can be adjusted accordingly in pairs or adjusted at an angle all together.

The spacing of the blades relative to each other determines the size of the individual rolls or logs produced. It follows that the consistency of this spacing affects the consistency of the product. Also, the spacing and configuration of the blades relative to the dimensions of the log affects the amount of waste produced by cutting the log. If the log is longer than the end-to-end distance of the array of blades, one or both ends may produce rolls which are too small to be of commercial value. The ends, or cookies, are waste material and are generally disposed of. It is desirable to reduce the size of these cookies, or to eliminate them if possible, so as to reduce the overall waste of the production. To the extent that the ends or cookies are not eliminated, it may be necessary to remove them from the apparatus such as by way of a secondary chute. This chute may deliver the ends (cookies) directly to a container for discarding or recycling, or the chute may deliver the cookies to a conveyor which removes them from the apparatus.

Depending on the speed of the sprocket wheel, the log may have different positions at the time the blades are removed from the cutting area. It is preferred that the cutting is complete and the blades are removed by the time the log is centered on the vertical axis. It is preferred that the blades operate at preferably surface speeds but also at variable speeds if it minimizes vibrations in the apparatus.

In an alternative embodiment, the shape of the pocket and the action of the saw blades may eliminate the need to clamp the roll to the sprocket. Deformation of the substrate may occur if clamps, skates, or other devices are used to substantially close the opening of the pocket during the cutting procedure. Use of these devices also provides increased difficulties in the maintenance and cleaning of the apparatus as a whole. The shape of the pocket also provides for support of the divided roll after the cutting procedure. The angled configuration prevents the roll from rotating out of the pocket until the substrate is centered at an angle of about 10-degrees below the vertical axis. Thus, the shape of the pocket provides for the substrate to be dropped into the pocket, secured through the cutting procedure, supported after cutting, and delivered to an exit point.

In yet another embodiment of the disclosure that pertains to dispensing individual logs into individual rolls from the sprocket may take the form of allowing the log to fall from the pocket. The sprocket and/or pocket may be equipped with a movable finger to eject the rolls from the pocket, for example in a substantially horizontal motion. If the rolls are allowed to fall from the pocket, it may be desirable to prevent this dispensing until the roll has been rotated to an exit point. This may be accomplished by methods known to those skilled in the art. In any of these embodiments, an exit dead plate may also be employed to guide the dispensed roll to the desired location. A pivoting exit plate may be used to direct the rolls to two or more different locations.

The method of transporting, cutting, and handling substrates provided for by the described apparatus enables the cutting of both dry and wet substrates. Distortion of the finished product, especially in terms of shape and cut squareness, is minimized. All components of this apparatus are preferably constructed from materials which are resistant to corrosion.

In another embodiment, a sprocket wheel is not required. In this embodiment a machine model available from PCMC, for example, is used for cutting logs with circular blades. However, instead of using circular blades to cut logs, stationary bandsaw blade may be utilized. The bandsaw blade used is preferably smooth but may be toothed. Two or more cutting lanes, preferably two to forty are used. The bandsaw blade(s) move(s) in the direction the substrate (or log) travels. This means that the logs may move continuously instead of stopping to index for each roll. The width and productivity of the rewinder line dictate the appropriate model of bandsaw and how many bandsaws may be required in the line. A bandsaw blade enables high productivity and continuous blade sharpened quality in comparison to a circular logsaw blade.

In a further embodiment, the apparatus may be positioned horizontally, vertically, or at any angle in between 0 degrees and 180 degrees. The blade used is a bandsaw blade, in which the cutting edge of the blade is preferably thin and smooth, and the apparatus may have one or two main pulley drives depending on the thickness and weight of the substrate.

All documents cited in the Detailed Description are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by references, the meaning or definition assigned to the term in this written document shall govern.

Those skilled in the art will recognize that the present disclosure may be manifested in a variety of forms other than the specific embodiments described and contemplated herein. Specifically, the various features described with respect to the various embodiments and figures should not be construed to be applicable to only those embodiments and/or figures. Rather, each described feature may be combined with any other feature in various contemplated embodiments, either with or without any of the other features described in conjunction with those features. Accordingly, departure in form and detail may be made without departing from the scope of the present disclosure as described in the appended claims.

1. A cutting apparatus for cutting flexible substrates having a longitudinal axis, the apparatus comprising:
a frame having an upper surface lying in a first plane;
one or more pulleys attached to the frame;
one or more motors for driving one or more pulleys;
an endless stationary bandsaw blade mountably engaged with one or more pulleys and arranged to define at least one cutting lane, the bandsaw blade having an upper and lower edge; and
a moveable carriage for receiving and advancing the substrate through a cutting lane thereby cutting the substrate along a plane which is orthogonal to the longitudinal axis of the substrate.

2. The apparatus according to claim 1, wherein the substrate is cylindrical rolls, logs, pipe, tube, food product, dry or wet roll of paper or wet wipes.

3. The apparatus according to claim 1, wherein the bandsaw blade is smooth.

4. The apparatus according to claim 1, wherein the bandsaw blade further comprises a plurality of cutting teeth disposed on at least the upper edge and defining the cutting plane.

5. The apparatus according to claim 1, wherein the bandsaw blade is serpentine and forms a loop.

6. The apparatus according to claim 1, wherein the moveable carriage is a sprocket wheel, index conveyor, or a bomb-bay door.

7. The apparatus according to claim 1, wherein there are from about 2 to about 40 cutting lanes.

8. The apparatus according to claim 1, wherein the motor is a servomotor.

9. The apparatus according to claim 1, further comprising a sharpening tool.

10. The apparatus according to claim 9, wherein the sharpening tool is attached to the frame.

11. The apparatus according to claim 1, wherein the bandsaw saw blade is from about 5 thousands of an inch to about 60 thousands of an inch thick.

12. (canceled)

13. The apparatus according to claim 6, wherein the sprocket wheel comprises a plurality of evenly spaced apart pockets comprise from about two to about forty pockets.

14. The apparatus according to claim 1, wherein the moveable carriage has a holding device to cover the substrate in the pocket.

15. The apparatus according to claim 14, wherein the holding device is a dead plate.

16. The apparatus according to claim 1, comprising a plurality of pulleys that may be adjusted to adjust the length of the cut substrate.

17. A method for cutting flexible substrates having a longitudinal axis, the method comprising:
depositing and holding the substrate into a moveable carriage;
rotating the moveable carriage with a motor;
a motor for driving one or more pulleys through one or more cutting lanes wherein the pulleys move an endless stationary bandsaw blade;
continuously cutting the substrates at the same location during each pass with the bandsaw blade; and optionally
sharpening the bandsaw blade with a sharpening blade tool while cutting the substrates.

18. The method according to claim 17, wherein the substrate is cylindrical rolls, logs, pipe, tube, food product, dry or wet roll of paper or wet wipes.

19. The method according to claim 17, wherein the blade is serpentine and forms a loop.

20. The method according to claim 17, wherein the bandsaw blade is smooth.
